(19) United States
(12) Patent Application Publication
(10) Pub. No.: US 2022/0240728 A1
(43) Pub. Date: Aug. 4, 2022

(54) Shower Curtain Rod With Bluetooth and Speakers

(71) Applicants: Abdulaziz Alanazi, Centerville, UT (US); Alys Mead, Centerville, UT (US)

(72) Inventors: Abdulaziz Alanazi, Centerville, UT (US); Alys Mead, Centerville, UT (US)

(21) Appl. No.: 17/163,313

(22) Filed: Jan. 29, 2021

(51) Int. Cl. A47K 3/28; A47K 3/38; H04R 1/02; G08C 17/02

(52) U.S. Cl. CPC A47K 3/281; A47K 3/38; H04W 4/80; G08C 17/02; H04R 1/025

(57) ABSTRACT

The present disclosure provides a shower curtain rod having an integrated entertainment system comprising a controller and a wireless module that can be used to operate sets of RGB LED lights and speakers set into the length of the rod body, as well as other types of accessories. The technological components are set within the hollow tubular body of the rod and thus protected from water damage. The rod can be provided as a single piece or multiple connected pieces, and can also be provided as a part of a kit including a remote control with which a user can control the entertainment system.

### CROSS REFERENCE TO RELATED APPLICATIONS

The present application claims the benefit and priority of US provisional application no. 62/967,218, filed Jan. 29 2020, which is incorporated herein by reference.

### FIELD OF INVENTION

The present invention relates generally to the field of shower accessories. More specifically, the present invention relates to a shower curtain rod having an integrated entertainment system and wireless communications unit.

### BACKGROUND

Household products improved by having integrated technological components are a part of the home-goods market that is a high growth sector with increasing interest form consumers and manufacturers alike. An example of a household product that has remained much the same in terms of fundamental design over the years is the shower curtain rod. Shower curtain rods of a variety of colors and materials are available, yet the underlying design remains consistent, despite the fact that the hollow tubular design of shower curtain rods provides much space for integrated improvements.

Most shower curtain rods are retractable or extendable, are commonly constructed from materials such as PVC and stainless steel, and are usually installed between two walls on opposing sides of a shower fitting or bathtub, with the curtain hangers typically being attached to or hanging from the rod once installed.

Often the curtain hangers are designed with circular loops that surround the rod. In other cases the rod will have an indented track running along its length which is positioned underneath during installation and which houses a one or more slidable curtain attachment elements that can be moved back and forth along the length of the track. In this latter design, the user can use the hangers in place of or in addition to the previously mentioned curtain hangers, allowing for customization.

It is within this context that the present invention is provided.

### SUMMARY

The present disclosure provides a shower curtain rod having an integrated entertainment system comprising a controller and a wireless module that can be used to operate sets of RGB LED lights and speakers set into the length of the rod body, as well as other types of accessories. The technological components are set within the hollow tubular body of the rod and thus protected from water damage. The rod can be provided as a single piece or multiple connected pieces, and can also be provided as a part of a kit including a remote control with which a user can control the entertainment system.

Thus, according to one aspect of the present disclosure there is provided a shower curtain rod having an integrated entertainment system, comprising: a power unit, a wireless communications unit; a controller; one or more speakers; one or more sets of RGB LED lights; and one or more hollow tubular rods encapsulating the power unit, wireless communications unit, and controller, wherein the one or more speakers and one or more sets of RGB LED lights are set into outer walls of the one or more rods, and wherein each rod further comprises an indented track running along its length configured to receive one or more shower curtain attachment elements.

In some embodiments, the rod further comprises one or shower curtain attachment elements slidably connected to the indented track of the one or more rods.

Furthermore, the one or more shower curtain attachment elements may each comprise a hook for attaching a curtain.

Alternatively, the one or more shower curtain attachment elements may each comprise a loop for attaching a curtain.

Each rod may further comprise an electric motor operated by the controller and configured to slidably adjust the positions of the one or more curtain attachment elements.

In some embodiments, the wireless communications unit comprises a Bluetooth control module, and wherein the controller is configured to receive commands via the Bluetooth control module.

In some embodiments, the wireless communications unit comprises a radio control module, and wherein the controller is configured to receive commands via the radio control module.

In some embodiments, the rod further comprises a microphone connected to the controller, and wherein the controller is configured to receive and recognise one or more speech commands via the microphone.

In some embodiments, the shower curtain rod comprises two or more hollow tubular rods connected together by a coupling element having first and second female attachment points each configured to receive an end of the one or more rods.

Furthermore, the coupling element may comprise an indented portion which acts as a bridge between the shower curtain attachment element tracks of connected rods.

In some embodiments, the one or more rods are straight. In some embodiments, the one or more rods are curved. In some embodiments, the controller is configured to receive instructions from one or more external user devices.

In some embodiments, each of the one or more rods is fitted with a ring having a greater diameter than the rod to allow for expansion of the opposing ends of the rod.

According to another aspect of the present disclosure there is provided a kit comprising a shower curtain rod according to the above described embodiments and a remote control configured to wirelessly provide the controller of the shower curtain rod with one or more commands for operating the speakers and sets of RGB LED lights.

The remote control may also operate the electric motor for slidably adjusting the positions of the shower curtain attachment elements.

### BRIEF DESCRIPTION OF THE DRAWINGS

Various embodiments of the invention are disclosed in the following detailed description and accompanying drawings.

FIG. 1 illustrates a first example configuration of a shower curtain rod according to the present disclosure formed of a single straight tubular body.

FIG. 2 illustrates a second example configuration of a shower curtain rod according to the present disclosure formed of two separate but connected straight tubular bodies.

FIG. 3 illustrates an example configuration of a coupling element for use in connecting separate tubular bodies of the rod.

FIG. 4 illustrates a cross-sectional view of one example configuration of a shower curtain rod according to the present disclosure wherein curtain attachment elements with hooks are set along an indented track running along the bottom of the rod body.

FIG. 5 illustrates a cross-sectional view of another example configuration of a shower curtain rod according to the present disclosure wherein curtain attachment elements with hooks are set along an indented track running along the side of the rod body.

FIG. 6 illustrates a cross-sectional view of another example configuration of a shower curtain rod according to the present disclosure wherein curtain attachment elements with loops are set along an indented track running along the bottom of the rod body.

FIG. 7 illustrates a cross-sectional view of another example configuration of a shower curtain rod according to the present disclosure wherein curtain attachment elements with loops are set along an indented track running along the side of the rod body.

FIG. 8 illustrates an example configuration of a remote controller suitable for use as a wireless controller for a shower curtain rod entertainment system according to the present disclosure and which can be provided as part of a kit.

FIG. 9 illustrates a third example configuration of a shower curtain rod according to the present disclosure formed of a single curved tubular body.

FIG. 10 illustrates a fourth example configuration of a shower curtain rod according to the present disclosure formed of two separate but connected curved tubular bodies.

FIG .11 illustrates an example configuration of a curved coupling element for use in connecting separate tubular bodies of the rod.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure relates to a shower curtain rod and embodied system including LED RGB color light, wireless communications modules having capabilities such as Bluetooth, speakers, and in some examples an accompanying radiofrequency controller for operating the entertainment system. A motor may also be included to open and close the shower curtain automatically by remote control, or in cases where a microphone is provided in the shower curtain rod, by voice recognition.

The disclosed shower curtain rod and integrated entertainment system increase user enjoyment of showers and baths, allowing connection to external user devices such as mobile phones and removing the need for users to bring portable speakers into a bathroom to listen to music or podcasts as they wash.

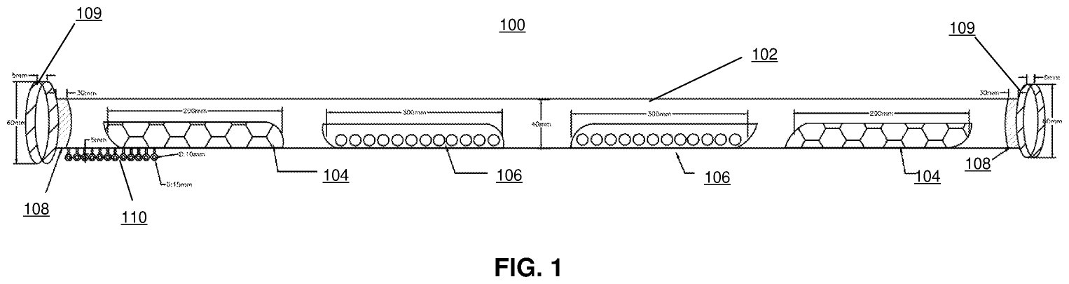

Referring to FIG. 1, a first example configuration of a shower curtain rod 100 according to the present disclosure is shown formed of a single straight tubular body 102.

The tubular body 102 is hollow, with electrical components for an integrated entertainment system contain inside, and sets of speakers 104 and RGB LED lights 106 set into the walls of the rod at intervals.

In the present example and other examples the body of the rod is a set length, but has extendable portions 108 at either end with ring fittings 109 for attaching to bathroom walls, the ring fittings having a diameter greater than the diameter of the rod body.

Example dimensions of the various components of the rod body are shown in FIG. 1, in the present example the main length is 1860 mm, approximately 72″, but the length could vary between 36″-144″ for example. The rod may for example measure 40 mm in diameter with 300 mm LED light strips and speakers measuring 200 mm in length and 20mm in height. The rings for extending the rod length may for example measure 5mm in thickness and 60 mm in diameter.

Also shown are a set of loops 110 for attaching and supporting a shower curtain. As will be explained below in greater detail these loops are held by shower curtain attachment elements set into an indented track that runs along the length of the rod body 102 and facilitates free movement of the loops along its length. In some examples the rod body may have an integrated motor for moving the curtain via remote control.

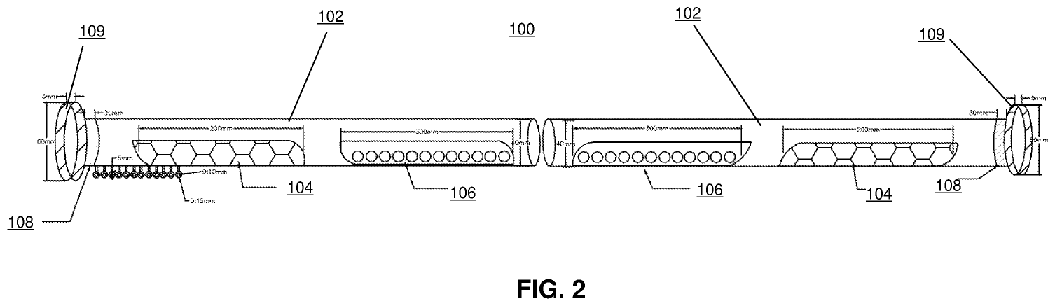

Referring to FIG. 2, a second example configuration of a shower curtain rod 100 according to the present disclosure is shown wherein the rod is formed of two separate but connected straight tubular bodies 102, each having one extendable end and ring fitting as described above.

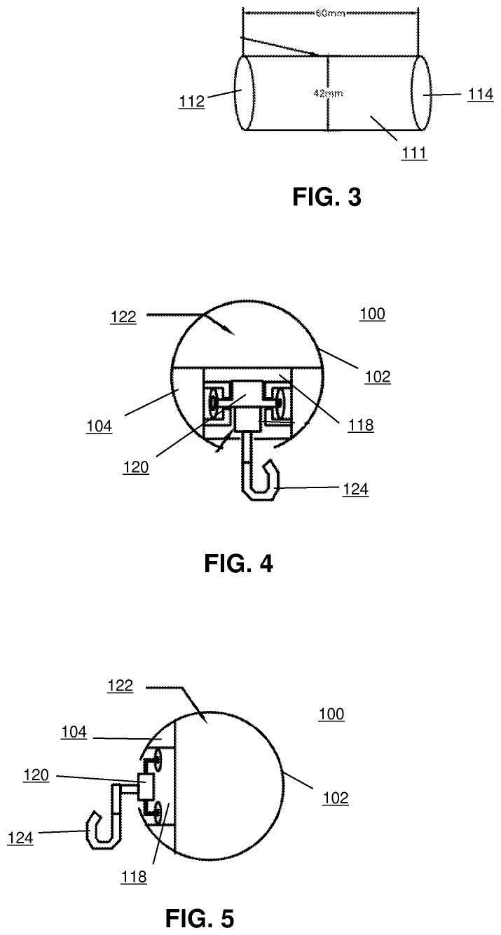

FIG. 3 shows a coupling element 111 that can be used to connecting the separate tubular bodies of the rod of FIG. 2. It has two opposing female openings 112 and 114 for ends of the rods to be inserted and may also comprise a bridge for the indented track that the shower curtain attachment elements move along. It is hollow to allow for wires to be threaded through such as a power cable for the internal electric components of the rod.

An example coupling piece may measure 60 mm in length and 42 mm in diameter, wherein the coupling piece wraps around the rod at its center in order to hold the two halves of the main rod body together.

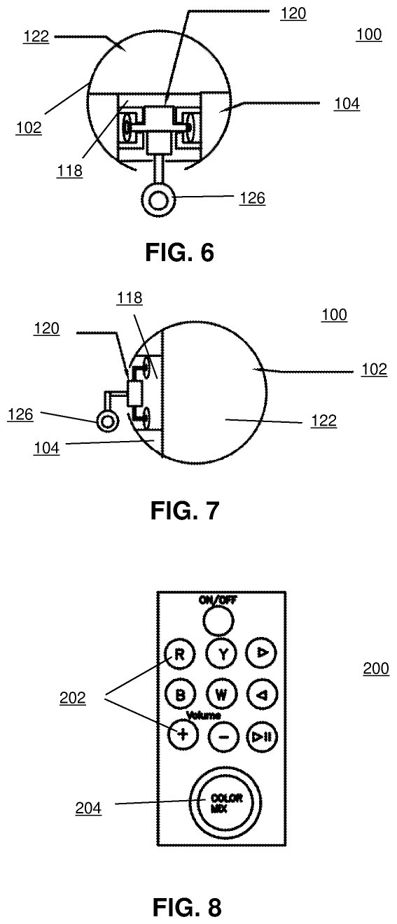

Referring to FIG. 4, FIG. 5, FIG. 6, and FIG. 7, cross-sectional views of example internal configurations of the shower curtain rod 100 are shown with the indented track 118, shower curtain attachment elements 120, speakers 104, and space for internal components 122 such as power modules, wireless communications modules such as Bluetooth and radiofrequency, and various other components can be installed. Bluetooth is a preferred design choice, and can be built into a PCB circuit board connected to a microprocessor inside the rod allowing it to be controlled by a phone or any other device that can connect through Bluetooth such as TV, Radio, smartphones, and headphones.

FIG. 4 and FIG. 5 show shower curtain attachment elements 120 with hooks 124, placed either on the side or bottom of the rod body, and FIG. 6 and FIG. 7 show similar variations with loops 126.

The curtain attachment elements or “curtain carts” can travel all the way to either end of the rod 100 and there may be any number of such, for example there may be 12 provided with a single rod system 100.

Referring to FIG. 8, an example configuration of a remote controller 200 suitable for use as a wireless controller for the shower curtain rod entertainment system 100 is shown. The controller 200 can be provided as part of a kit along with the rod 100.

The remote control 200 of the present example may operate via radiofrequency to communicate with a wireless communications unit and controller or microprocessor on the shower curtain rod 100. The illustrated remote 200 has ten push buttons 202 for controlling the LEDs, speaker, and entire system 100 and a “Color Mix” potentiometer 204 to change the LED colors on the rod since LED RGB light is an LED that comes with the ability to change the light different colors. RGB LED can turn to different colors depending on the current and voltage that power the LED. The LED RGB is may for example be powered by a 5-9VDC rechargeable battery and the potentiometer will change the amount of power being directed to the LED from the battery.

The ten buttons are: W white color LED; R red color LED; Y yellow color LED; B blue color LED;; ON/OFF; and then Forward; Reverse; Run; and Stop buttons to control the speakers. The remote control may use a battery of 5-12VDC.

The remote control 200 is waterproof, as of course is the shower curtain rod 100.

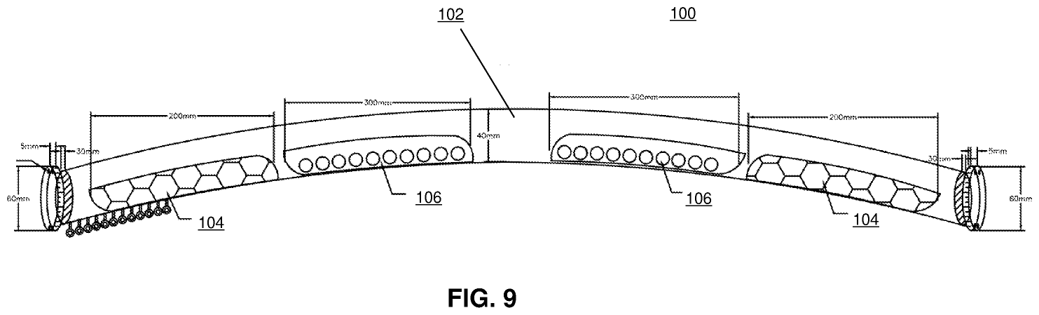

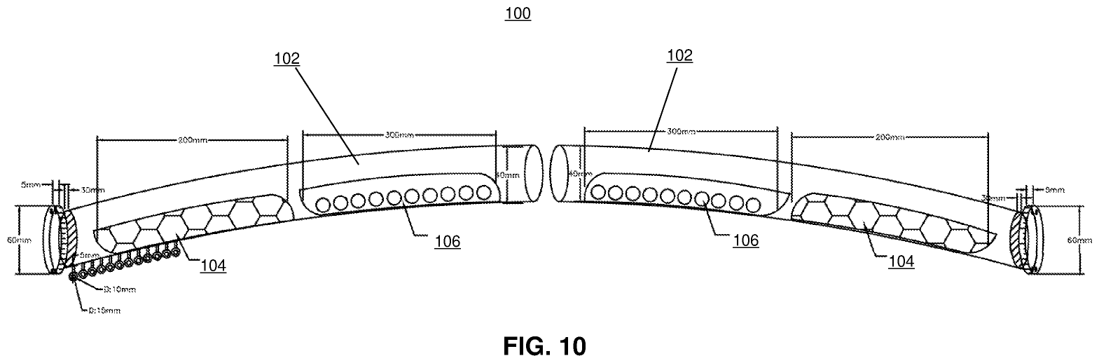

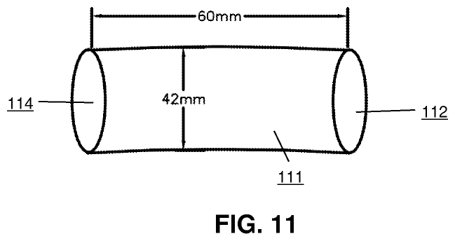

FIG. 9 and FIG. 10 illustrate alternative configurations of the rod 100 shown in FIG. 1 and Fig. 2, with the rod body/bodies 102 taking on a curved shape. This is to emphasize that a variety of shapes and sizes of the rod of the present disclosure can be used.

FIG.11 shows an example configuration of a curved coupling element 111 for use in connecting separate tubular bodies of the rod.

The curtain rod can be made of any suitable materials including but not limited to stainless steel and PolyVinyl-Chloride (PVC), and can be produced in a variety of colors.

The rod body can also be in a variety of shapes including straight, curved, square, circular and others not mentioned explicitly herein.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the shower curtain rod and integrated entertainment system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A shower curtain rod having an integrated entertainment system, comprising:
a power unit,
a wireless communications unit,
a controller;
one or more speakers;
one or more sets of RGB LED lights; and
one or more hollow tubular rods encapsulating the power unit, wireless communications unit, and controller, wherein the one or more speakers and one or more sets of RGB LED lights are set into outer walls of the one or more rods, and wherein each rod further comprises an indented track running along its length configured to receive one or more shower curtain attachment elements;
the shower curtain rod further comprising one or shower curtain attachment elements slidably connected to the indented track of the one or more rods
wherein each rod further comprises an electric motor operated by the controller and configured to slidably adjust the positions of the one or more curtain attachment elements.

2. (canceled)

3. A shower curtain rod according to claim 1, wherein the one or more shower curtain attachment elements each comprise a hook for attaching a curtain.

4. A shower curtain rod according to claim 1, wherein the one or more shower curtain attachment elements each comprise a loop for attaching a curtain.

5. (canceled)

6. A shower curtain rod according to claim 1, wherein the wireless communications unit comprises a Bluetooth control module, and wherein the controller is configured to receive commands via the Bluetooth control module.

7. A shower curtain rod according to claim 1, wherein the wireless communications unit comprises a radio control module, and wherein the controller is configured to receive commands via the radio control module.

8. A shower curtain rod according to claim 1, further comprising a microphone connected to the controller, and wherein the controller is configured to receive and recognise one or more speech commands via the microphone.

9. A shower curtain rod according to claim 1, comprising two or more hollow tubular rods connected together by a coupling element having first and second female attachment points each configured to receive an end of the one or more rods.

10. A shower curtain rod according to claim 9 wherein the coupling element comprises an indented portion which acts as a bridge between the shower curtain attachment element tracks of connected rods.

11. A shower curtain rod according to claim 1, wherein the one or more rods are straight.

12. A shower curtain rod according to claim 1, wherein the one or more rods are curved.

13. A shower curtain rod according to claim 1, wherein the controller is configured to receive instructions from one or more external user devices.

14. A shower curtain rod according to claim 1, wherein each of the one or more rods is fitted with a ring having a greater diameter than the rod to allow for expansion of the opposing ends of the rod.

15. A kit comprising a shower curtain rod according to claim 1 and a remote control configured to wirelessly provide the controller of the shower curtain rod with one or more commands for operating the speakers and sets of RGB LED lights.

16. A kit comprising a shower curtain rod according to claim 5 and a remote control configured to wirelessly provide the controller of the shower curtain rod with one or more commands for operating the speakers, the one or more sets of RGB LED lights, and the electric motor for slidably adjusting the positions of the shower curtain attachment elements.
